(19) United States
(12) Patent Application Publication
(10) Pub. No.: US 2017/0348892 A1
(43) Pub. Date: Dec. 7, 2017

(54) POLYPROPYLENE PREFORM

(71) Applicant: DISCMA AG, Hunenberg (CH)

(72) Inventors: Yuichi OKUYAMA, Kanagawa (JP); Kazuhiko SHIMUZU, Kanagawa (JP)

(21) Appl. No.: 15/521,139

(22) PCT Filed: Oct. 5, 2015
(86) PCT No.: PCT/JP2015/005062

§ 371 Date: Apr. 21, 2017

(30) Foreign Application Priority Data
Oct. 24, 2014 (JP) 2014-217364

(51) Int. Cl. B29C 49/12; B29C 49/46; B29C 49/00; B29K 23/00; B29K 105/00; B29L 31/00

(52) U.S. Cl. CPC B29C 49/12; B29C 49/46; B29C 49/0005; B29C 2049/465; B29K 2105/258; B29L 2031/712; B29K 2023/12

(57) ABSTRACT

A polypropylene preform for biaxial stretch blow molding using a liquid as a pressurizing medium. The polypropylene material, when measured with a differential scanning calorimeter (DSC), has a relationship between the melting start temperature (Ts), melting peak temperature (Tm), and melting enthalpy (ΔHm) exhibited as (Tm-Ts)ΔHm.

### TECHNICAL FIELD

The present invention relates to a polypropylene preform and more particularly to a polypropylene preform for biaxial stretch blow molding that uses a liquid as the pressurizing medium.

### TECHNICAL BACKGROUND

In recent years, plastic blow molded containers have been used in multiple applications due to their countless superior characteristics, such as being lightweight and having an excellent appearance. Generally, this kind of container is molded by biaxial stretch blow molding a preform, formed in a closed-ended tube shaped test-tube shape, by stretching in the axial direction using a stretch rod and radially stretching into an expanded state by blowing air into the inside of the preform from a nozzle inserted densely into a tube opening portion of the preform, in a state heated to a temperature where stretching properties can be realized.

Meanwhile, in the Japanese Unexamined Patent Application Publication No. 2000-43129, an invention related to a plastic container molding method is recorded where a preform is blow molded by supplying a liquid instead of air as the pressurizing medium. Furthermore, according to this manner of biaxial stretch blow molding that uses a liquid (hereinafter, sometimes referred to as “liquid blow molding”), in the liquid used as a pressurizing medium, the filling process can be omitted by using water, tea, or soft drinks and the like that fills a container as a product, thereby simplifying the production line.

### SUMMARY OF INVENTION

However, problems are associated with this type of liquid blow molding, particularly in liquid blow molding using a polypropylene preform, in that the preform may break during molding and the sort of conditions that allow for stable molding are currently still being researched and are not yet widely known.

An object of the present invention is to provide a technique that can perform stable molding for liquid blow molding in a polypropylene preform for biaxial stretch blow molding that uses liquid as a pressurizing medium.

In accordance with the principles of the present invention, a polypropylene preform is provided for biaxial stretch blow molding that uses a liquid as a pressurizing medium, wherein, when measured with a differential scanning calorimeter (DSC), the relationship between the melting start temperature (Ts), melting peak temperature (Tm), and melting enthalpy (ΔHm) is (Tm-Ts)ΔHm=0.60-1.00.

The inventors of the present invention have unexpectedly found that the melting start temperature (Ts), the melting peak temperature (Tm), and the melting enthalpy (ΔHm) contribute greatly to stable molding when the preform is made of a polypropylene resin. Specifically, when the melting peak is sharp (the difference between the melting start temperature and the melting peak temperature is small), the crystalline portion of the resin reaches the melting peak temperature once it begins to melt, and although the melted amount increases excessively making it difficult to maintain the shape of the preform, it was discovered that the melting of the crystalline portion included in the resin becomes easy to control if the melting peak is broad (the difference between the melting start temperature and the melting peak is large). Furthermore, it was discovered that when the melting enthalpy is too small, the crystalline portion melts excessively and it is difficult to maintain the shape of the preform, and conversely, when it is too large, the crystalline portion that does not melt becomes too numerous and ruptures easily due to the preform not stretching sufficiently. That is, for stable molding, the balance between the melting peak and the melting enthalpy is critical, and when further investigating this point, it was found that when the melting start temperature (Ts), the melting peak temperature (Tm), and the melting enthalpy (ΔHm) satisfy the relationship of (Tm-Ts)/ΔHm=0.60˜1.00, there are no problems such as breakage of the preform, and stable molding can be performed.

According to the present invention, in liquid blow molding using a polypropylene preform, there are no problems such as breakage of the preform during molding, and it is possible to perform stable molding.

### BRIEF DESCRIPTION OF THE DRAWINGS

FIG. 1 is a partial cross-sectional view illustrating one embodiment of a polypropylene preform for liquid blow molding according to the present invention.

FIG. 2 is a side view illustrating a container shaped from the preform of FIG. 1 using liquid blow molding.

FIG. 3 is a graph illustrating one example of measurement results from the differential scanning calorimeter (DSC).

### DETAILED DESCRIPTION

One embodiment of a propylene preform (hereinafter, at times referred to as “preform”) for liquid blow molding according to the present invention will be described below in further detail.

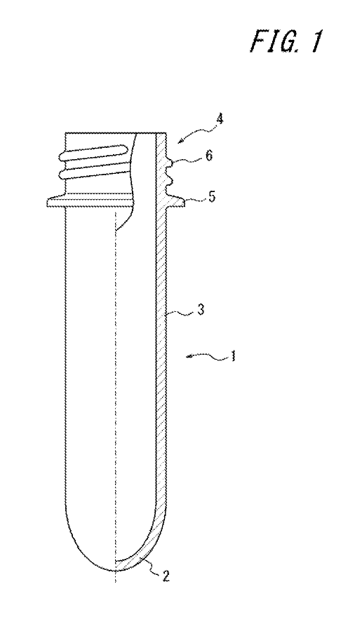

In FIG. 1, reference numeral 1 illustrates an embodiment of a preform according to the present invention. The preform 1 is made of polypropylene (PP), which has an overall test tube shape. More specifically, composed of a semispherical shell shaped bottom portion 2 and a cylindrical body portion 3 connected to the bottom portion 2, and an opening portion 4 for opening at the top of the body portion 3. In the opening portion 4, a disc shaped neck ring 5 is provided, and a male threaded portion 6 is provided above the neck ring 5. The preform 1 of the illustrative embodiment has a weight of 9 g, a cylinder part outer diameter of 19.4 mm, an average body portion thickness of 2.3 mm, and the downward height of a neck extending from the lower surface of the neck ring to the lower surface of the bottom portion 2 is 70 mm. Note that this manner of preform 1, in addition to injection molding, can also be produced by compression molding or extrusion blow molding.

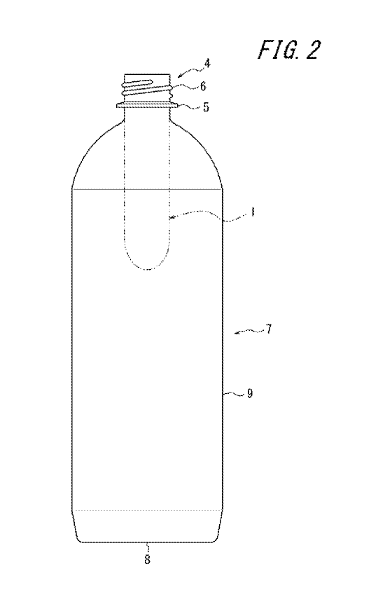

Furthermore, when performing liquid blow molding using the preform 1, the preform 1, heated to a temperature capable of realizing a stretching effect, is attached to a molding die (not shown) having a cavity in the shape of the desired container, and molded into the desired container by axially stretching the preform with a stretching rod of a blow molding device (not shown) and radially stretching into an expanded state by a pressurizing liquid injected into the preform 1 by a nozzle presented to the opening portion 4. In the resulting container 7, as illustrated in FIG. 2, the bottom portion 2 and the body portion 3 of the preform 1 are stretched, but not the opening portion 4, and the container 7 is provided as a bottomed cylindrical shaped container (has a cylindrical shaped bottom portion 8 and a cylindrical shaped body portion 9). Furthermore, in the illustrative example, the body portion outer diameter is 66 mm, the average thickness of the body portion is 0.18 mm, the height extending from the lower surface of the neck ring to the lower surface of the bottom portion is 195 mm, and the fill capacity is 420 ml.

There are three varieties of polypropylene; homopolymer, random copolymer, and block copolymer (impact copolymer), but according to the principles of the present invention, any of these may be used if they are 0.60 to 1.00=(Tm-Ts)/ΔHm. Random copolymer and block copolymer are used in the present example. Note that other than being able to use random copolymer and block copolymer individually, a mixture of these may also be used.

Furthermore, in the preform according to the present invention, the melting start temperature (Ts), the melting peak temperature (Tm), and the melting enthalpy (ΔHm) in the measurement of the differential scanning calorimeter (DSC) fulfill the relationship of 0.60 to 1.00=(Tm-Ts)/ΔHm. Here, in the differential scanning calorimeter (DSC) measurement, a sample extracted from a predetermined place on the preform 1 is set in the differential scanning calorimeter, the temperature at a set speed (10° C./minute), and a melting enthalpy (ΔHm) is calculated from the surface of the endothermic peak along with the melting that is realized is the temperature scope of 40 to 200° C. Furthermore, the predetermined place on the preform 1 is a place where stretching has not been carried out, and when using a container after liquid blow molding, is measured by the sample extracted from the opening portion of an un-stretched portion.

### EXAMPLES

Liquid blow molding was performed using a variety of preforms where the type of polypropylene was changed, and confirmation was performed on whether or not stable molding could be performed. The type of polypropylene in each preform is just as illustrated in Table 1, which is presented as FIG. 4 in the drawings. In Table 1 (FIG. 4), “homo” is the homopolymer, “random” is the random copolymer, and “block” is the block copolymer (impact copolymer). Furthermore, comparative examples 1 and 2 and examples 1 through 10 are resins of individual grades respectively, but example 11 is a mixture of the random copolymer used in example 5 and the block copolymer used in example 8 (the ratio of block copolymer is 20% of the whole), and example 12 is a mixture of the random copolymer used in example 5 and the block copolymer used in example 9 (the ratio of block copolymer is 20% of the whole).

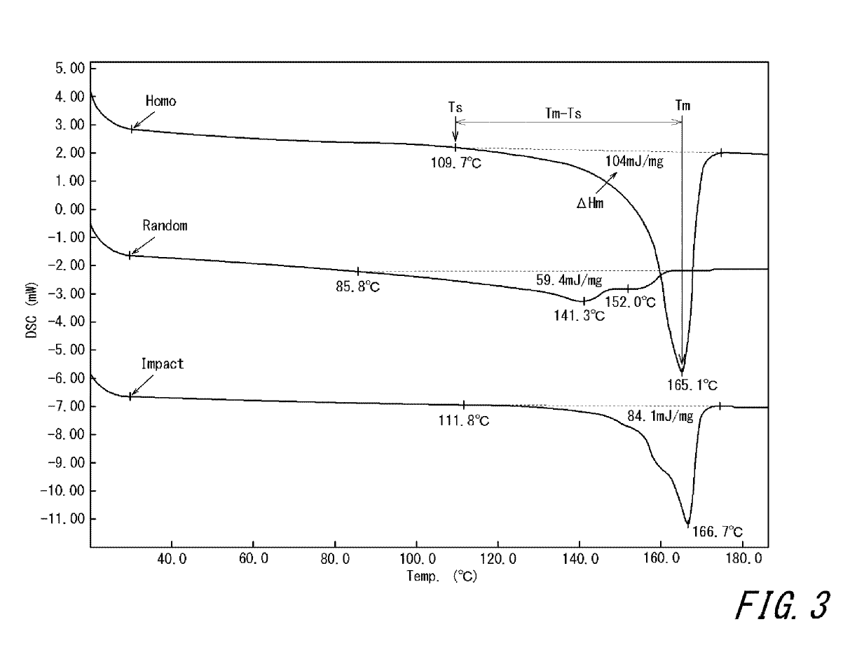

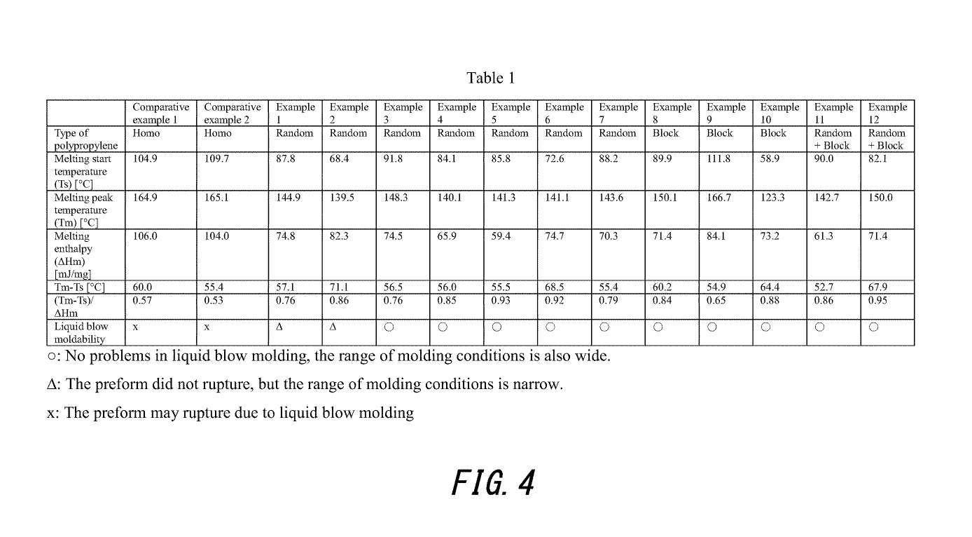

Furthermore, in the examples extracted from the comparative examples 1 and 2 and the examples 1 through 12, the melting start temperature (Ts), the melting peak temperature (Tm), and the melting enthalpy (ΔHm) obtained from the measurement of the differential scanning calorimeter (DSC) are just as illustrated in Table 1 (FIG. 4). Note that FIG. 3 illustrates a portion of the measurement results obtained from the differential scanning calorimeter (DSC), and in FIG. 3, “Homo” illustrates comparative example 2, “Random” illustrates example 5, and “Impact” illustrates example 9.

In the liquid blow molding of the preform, before attaching to the molding die, a preform was used that was heated to 130° C. for a predetermined time. Furthermore, the pressurizing medium used was water, and the water temperature was set to 20° C. Furthermore, the temperature of the molding die was set to 20° C. Furthermore, the total vertical and horizontal stretching rate was approximately ten fold.

As illustrated in Table 1 (FIG. 4), in the preform where the melting start temperature (Ts), the melting peak temperature (Tm), and the melting enthalpy (ΔHm) in the measurement from the differential scanning calorimeter (DSC) fulfill (Tm-Ts)/ΔHm=0.60 to 1.00 (examples 1 through 12), there were no occurrences of problems where the preform ruptured and the like in liquid blow molding, and it was understood that stable molding could be performed. Particularly, in the preform that fulfills (Tm-Ts)/ΔHm=0.88 to 0.95, since the range of molding conditions is wide, it was understood that stable molding could be performed even with the addition of dispersion in mass production.

The composition of the present invention and the operation effect thereof were described above, but the preform according to the present invention is not limited to the embodiments stated above, and variety of changes within the scope according to the scope of claims are possible. For example, in the embodiment stated above, a container having a bottomed cylindrical shape and an internal capacity of 420 ml was described, but another shape such as a bottomed rectangular shape, as well as a more compound or a more large-sized container may be applied.

1. A preform for biaxial stretch blow molding that uses a liquid as a pressurizing medium, the preform comprising:
a body being generally tube shaped and having a closed end opposed by an open end;
the body being made of a polypropylene material; and
wherein, when measured by a differential scanning calorimeter (DSC), a relationship between melting start temperature (Ts), melting peak temperature (Tm), and melting enthalpy (ΔHm) of the preform is defined as (Tm-Ts)/ΔHm and is in the range of 0.60-1.00.

2. The preform according to claim 1, wherein the polypropylene material is a random copolymer.

4. The preform according to claim 1, wherein the polypropylene material is a block copolymer.

4. The preform according to claim 1, wherein the polypropylene material is a mixture of a random copolymer and a block copolymer.

5. The preform according to claim 4, wherein the block copolymer comprises 20% of the mixture.

6. The preform according to claim 1, wherein the melting start temperature (Ts) of the polypropylene material is in the range of about 58° C. to about 112° C.

7. The preform according to claim 1, wherein the melting peak temperature (Tm) of the polypropylene material is in the range of about 123° C. to about 167° C.

8. The preform according to claim 1, wherein the melting enthalpy (ΔHm) of the polypropylene material is in the range of about 59° C. to about 85° C.

9. The preform according to claim 1, wherein the difference between the melting peak temperature (Tm) and the melting start temperature (Ts) of the polypropylene material is in the range of about 52° C. to about 72° C.

10. The preform according to claim 1, wherein the melting start temperature (Ts) of the polypropylene material is in the range of about 58° C. to about 112° C., the melting peak temperature (Tm) of the polypropylene material is in the range of about 123° C. to about 167° C., and the melting enthalpy (ΔHm) of the polypropylene material is in the range of about 59° C. to about 85° C.
